(19) United States
(12) Patent Application Publication
(10) Pub. No.: US 2025/0031209 A1
(43) Pub. Date: Jan. 23, 2025

(54) TERMINAL CAPABILITY REPORTING METHOD AND APPARATUS, AND STORAGE MEDIUM

(71) Applicant: Beijing Xiaomi Mobile Software Co., Ltd., Beijing (CN)

(72) Inventor: Shengxiang GUO, Beijing (CN)

(73) Assignee: BEIJING XIAOMI MOBILE SOFTWARE CO., LTD., Beijing (CN)

(21) Appl. No.: 18/575,075

(22) PCT Filed: Jun. 30, 2021
(86) PCT No.: PCT/CN2021/103601

§ 371 Date: Dec. 28, 2023

(51) Int. Cl. H04W 72/21; H04W 8/24

(52) U.S. Cl. CPC H04W 72/21; H04W 8/24

(57) ABSTRACT

A terminal capability reporting method includes: reporting a target terminal capability to a base station, wherein the target terminal capability at least includes a maximum uplink duty ratio value corresponding to at least one antenna panel of a terminal. Also provided is a terminal capability reporting apparatus and a non-transitory computer-readable storage medium.

### CROSS REFERENCE TO RELATED APPLICATIONS

The present application is a U.S. national phase application of International Application No. PCT/CN2021/103601, filed on Jun. 30, 2021, and the entire contents thereof are incorporated herein by reference for all purposes.

### BACKGROUND

### Technical Field

The present disclosure relates to the field of communications, and in particular to a terminal capability reporting methods and apparatus, and storage medium.

### Description of the Related Art

The MPE (Maximum Permitted Emission) of the terminal is stipulated by the International Electrotechnical Association, and is related to the health of the human body under electromagnetic radiation. Therefore, the terminal needs to consider the uplink transmission power and at the same time meet the corresponding requirements of MPE to ensure that the electromagnetic radiation energy to the human body is within the specified range when the terminal is held in hand or used against the ear.

In this regard, the reporting of uplink duty cycle capability has been introduced for terminals.

### SUMMARY

Embodiments of the present disclosure provide a terminal capability reporting method and apparatus, and a storage medium.

According to a first aspect of an embodiment of the present disclosure, a terminal capability reporting method is provided. The method is applied to a terminal and includes reporting a target terminal capability to a base station, wherein the target terminal capability at least includes a maximum uplink duty cycle value corresponding to at least one antenna panel of the terminal.

According to a second aspect of an embodiment of the present disclosure, there is provided a terminal capability reporting method, applied to a base station and includes receiving a target terminal capability reported by a terminal, wherein the target terminal capability at least includes a maximum uplink duty cycle value corresponding to at least one antenna panel of the terminal.

According to a third aspect of an embodiment of the present disclosure, there is provided a terminal capability reporting apparatus, applied to a terminal and includes a reporting module, configured to report a target terminal capability to a base station, wherein the target terminal capability at least includes a maximum uplink duty cycle value corresponding to at least one antenna panel of the terminal.

According to a fourth aspect of an embodiment of the present disclosure, there is provided a terminal capability reporting apparatus, applied to a base station and includes a receiving module, configured to receive a target terminal capability reported by a terminal, wherein the target terminal capability at least includes a maximum uplink duty cycle value corresponding to at least one antenna panel of the terminal.

According to a fifth aspect of an embodiment of the present disclosure, there is provided a non-transitory computer-readable storage medium, wherein the computer-readable storage medium is stored with a computer program, and the computer program is used to execute the terminal capability reporting method according to any one of the first aspect.

According to a sixth aspect of an embodiment of the present disclosure, there is provided a non-transitory computer-readable storage medium, wherein the computer-readable storage medium is stored with a computer program, and the computer program is used to execute the terminal capability reporting method according to any one of the second aspect.

According to a seventh aspect of an embodiment of the present disclosure, there is provided a terminal capability reporting apparatus, including a processor and a memory configured to store instructions executable by the processor. The processor is configured to execute the terminal capability reporting method according to any one of the first aspect.

According to an eighth aspect of an embodiment of the present disclosure, there is provided a terminal capability reporting apparatus, including a processor and a memory configured to store instructions executable by the processor. The processor is configured to execute the terminal capability reporting method according to any one of the second aspect.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the invention and together with the description serve to explain the principles of the invention.

FIG. 1 is a schematic flowchart of a terminal capability reporting method according to an embodiment.

FIG. 2 is a schematic flowchart of another terminal capability reporting method according to an embodiment.

FIG. 3 is a schematic flowchart of another terminal capability reporting method according to an embodiment.

FIG. 4 is a schematic flowchart of another terminal capability reporting method according to an embodiment.

FIG. 5 is a schematic flowchart of another terminal capability reporting method according to an embodiment.

FIG. 6 is a schematic flowchart of another terminal capability reporting method according to an embodiment.

FIG. 7 is a schematic flowchart of another terminal capability reporting method according to an embodiment.

FIG. 8 is a block diagram of a terminal capability reporting apparatus according to an embodiment.

FIG. 9 is a block diagram of another terminal capability reporting apparatus according to an embodiment.

FIG. 10 is a schematic structural diagram of a terminal capability reporting apparatus according to an embodiment of the present disclosure.

FIG. 11 is a schematic structural diagram of another terminal capability reporting apparatus according to an embodiment of the present disclosure.

### DETAILED DESCRIPTION OF THE PREFERRED EMBODIMENTS

Embodiments will be described in detail herein, examples of which are illustrated in the accompanying drawings. When the following description refers to the drawings, the same numbers in different drawings refer to the same or similar elements unless otherwise indicated. The implementations described in the following embodiments do not represent all implementations consistent with the invention. Rather, they are merely examples of apparatus and methods consistent with aspects of the invention as detailed in the appended claims.

The terminology used in this disclosure is for the purpose of describing particular embodiments only and is not intended to be limiting of the disclosure. As used in this disclosure and the appended claims, the singular forms “a,” “the” and “the” are intended to include the plural forms as well, unless the context clearly dictates otherwise. It will also be understood that the term “and/or” as used herein refers to and includes any and all possible combinations of at least one associated listed item.

It should be understood that although the terms first, second, third, etc. may be used in this disclosure to describe various information, the information should not be limited to these terms. These terms are only used to distinguish information of the same type from each other. For example, without departing from the scope of the present disclosure, the first information may also be referred to as second information, and similarly, the second information may also be referred to as first information. Depending on the context, the word “if” as used herein may be interpreted as “while . . . ” or “when . . . ” or “in response to determining . . . ”.

The maxUplinkDutyCycle-FR2 is an optional capability for each band. When reporting by the terminal, it considers the situation of a single antenna panel. However, from the perspective of terminal development, multiple transmitting antenna panels is the designs that are being researched and popularized. Multiple antenna panels can not only help the terminal to avoid obstacles when using a single antenna panel during uplink transmission, but can also achieve transmit diversity in space to ensure the terminal's uplink throughput and stability. However, correspondingly, the currently reported max UplinkDutyCycle cannot accurately describe the uplink duty cycle capability of each antenna panel. If each antenna panel adopts a unified and lowest maxUplinkDutyCycle, it will lead to some antenna panels with higher uplink duty cycle capability not being able to transmit for a longer period of time, so the base station cannot correctly determine the uplink capability of the terminal and perform more reasonable schedule.

In order to solve this problem, the present invention provides a terminal capability reporting method. Hereinafter, the terminal capability reporting method provided by this disclosure is described firstly from the terminal side.

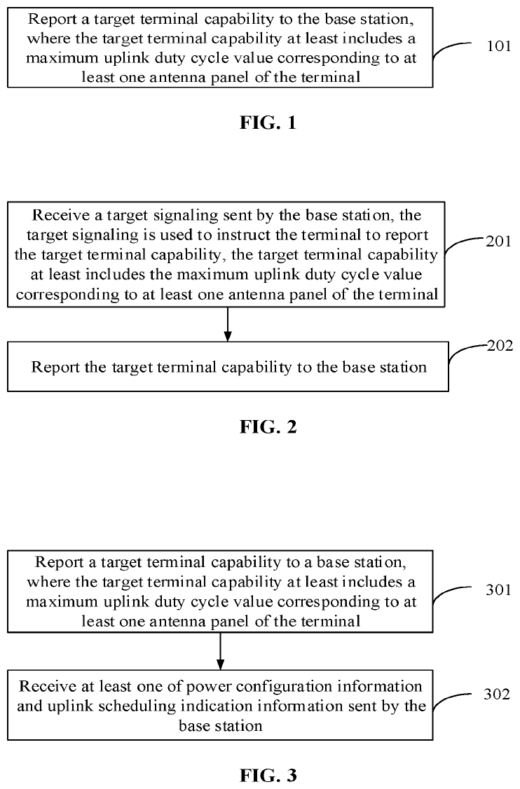

The embodiment of the present disclosure provides a terminal capability reporting method. Refer to FIG. 1, which is a flow chart of a terminal capability reporting method according to an embodiment, which can be applied for terminals. The method can include the following steps.

In step 101, a target terminal capability is reported to the base station, where the target terminal capability at least includes a maximum uplink duty cycle value corresponding to at least one antenna panel of the terminal.

In the embodiment of the present disclosure, the uplink duty cycle value refers to the ratio of the uplink time domain resources in one time unit when the base station configures time domain resources for the terminal. For example, the uplink duty cycle is 25%, which means that within one time unit, 25% of the time domain resources are configured by the base station for uplink transmission by the terminal. The maximum uplink duty cycle value refers to the maximum ratio of uplink time domain resources within the unit time unit.

An antenna panel may refer to the emission space corresponding to a set of antennas on a terminal. For example, the terminal includes 8 antennas, and each 4 antennas form a group. The emission space corresponding to each group of antennas is referred to an antenna panel, and the terminal has a total of 2 antenna panels.

In the above embodiment, the terminal may report the target terminal capability to the base station, where the target terminal capability at least includes the maximum uplink duty cycle value corresponding to at least one antenna panel. In order to assist the network side device to more reasonably schedule the terminal's transmitting power and uplink resources within the limits specified by the MPE based on the above target terminal capability. It improves the stability of the terminal's uplink transmission, and also improves the communication coverage and terminal throughput.

In some optional embodiments, refer to FIG. 2, which is a flow chart of a terminal capability reporting method according to an embodiment, which can be used in a terminal. The method can include the following steps.

In step 201, a target signaling sent by the base station is received. The target signaling is used to instruct the terminal to report the target terminal capability. The target terminal capability at least includes the maximum uplink duty cycle value corresponding to at least one antenna panel of the terminal.

In a possible implementation, the target signaling may be RRC (Radio Resource Control) signaling.

In step 202, the target terminal capability is reported to the base station.

In the above embodiment, the terminal can report the target terminal capability to the base station based on the target signaling sent by the base station, so as to assist the network side device to more reasonably schedule the terminal's transmitting power and uplink resources within the limits specified by the MPE based on the above target terminal capability. It improves the stability of the terminal's uplink transmission, and also improves the communication coverage and terminal throughput.

In some optional embodiments, the target terminal capability includes a maximum uplink duty cycle value corresponding to each antenna panel of the terminal.

In this embodiment of the present disclosure, the terminal may include the maximum uplink duty cycle value corresponding to each antenna panel in the target terminal capability reported to the base station according to the number of its own antenna panels.

For example, the target terminal capability includes the maximum uplink duty cycle value maxuplinkdutycycle-panel[i] corresponding to the antenna panel i, where i can be any integer. The specific numbering method can be determined by the terminal itself. maxuplinkdutycycle-panel[0] is the maximum uplink duty cycle value corresponding to antenna panel 0, maxuplinkdutycycle-panel[1] is the maximum uplink duty cycle value corresponding to antenna panel 1, and so on. That is to say, the terminal can report each maximum uplink duty cycle value maxuplinkdutycycle-panel[i] corresponding to the antenna panel i to the base station.

In the above embodiment, the terminal can report the maximum uplink duty cycle value corresponding to each antenna panel of the terminal to the base station by the target terminal capability, so as to assist the network side device to more reasonably schedule the terminal's transmitting power and uplink resources, based on the above target terminal capability, within the limits specified by the MPE. It improves the stability of the terminal's uplink transmission, and also improves the communication coverage and terminal throughput.

In some optional embodiments, the target terminal capability may include: target configuration information, the target configuration information is used to indicate at least one antenna panel configured to be available on the terminal; and the maximum uplink duty cycle value corresponding to the antenna panel configured as available.

For example, the terminal has a total of three antenna panels, namely antenna panel 0, antenna panel 1, and antenna panel 2. The target configuration information is used to indicate that antenna panel 2 is available, that is, antenna panel 2 transmits alone. The corresponding target configuration information can be Panelconfig2. The maximum uplink duty cycle value corresponding to antenna panel 2 is maxuplinkdutycycle-panel[2]. The target terminal capability reported by the terminal includes Panelconfig2 and maxuplinkdutycycle-panel[2].

In the above embodiment, the terminal may report target configuration information and maximum uplink duty cycle value to the base station as the target terminal capability, wherein the target configuration information indicates at least one antenna panel that is configured to be available, and the maximum uplink duty cycle value corresponds to each antenna panel configured as available; while the base station does not need to report the maximum uplink duty cycle value corresponding to each antenna panel to the base station. As a result, terminal resources are saved, and the network side device can be assisted to more reasonably schedule the terminal's transmitting power and uplink resources within the limits specified by the MPE.

In some optional embodiments, the target terminal capability may include: target configuration information, the target configuration information is used to indicate at least one antenna panel configured to be available on the terminal; and the maximum uplink duty cycle value corresponding to the antenna panel configured as available.

In the embodiment of the present disclosure, the terminal can maintain the following table 1.

TABLE 1
Target Terminal Capability

| | Corresponding Maximum Uplink |
|---|---|
| Target Configuration Information | Duty Cycle Value |
| Panelconfig1 | maxuplinkdutycycle-panel[1] |
| (Antenna panel 1 transmits alone) | |
| Panelconfig2 | maxuplinkdutycycle-panel[2] |
| (Antenna panel 2 transmits alone) | |
| Panelconfig3 | maxuplinkdutycycle-panel[3] |
| (Antenna panel 3 transmits alone) | |
| Panelconfig4 | maxuplinkdutycycle-panel[1], |
| (Antenna panels 1 and 2 transmit) | maxuplinkdutycycle-panel[2] |
| Panelconfig5 | maxuplinkdutycycle-panel[2], |
| (Antenna panels 2 and 3 transmit) | maxuplinkdutycycle-panel[3] |
| Panelconfig6 | maxuplinkdutycycle-panel[1], |
| (Antenna panels 1 and 4 transmit) | maxuplinkdutycycle-panel[3] |
| Panelconfig7 | maxuplinkdutycycle-panel[1], |
| (Antenna panels 1, 2 and 3 transmit) | maxuplinkdutycycle-panel[2], |
| | maxuplinkdutycycle-panel[3] |

The terminal can report the content of at least one row in Table 1 to the base station as the target terminal capability according to the actual configuration.

It can be understood that each element in Table 1 exists independently, and these elements are exemplarily listed in one table, but it does not mean that all elements in the table must exist at the same time as shown in the table. The value of each element is not dependent on the value of any other element in the table. Therefore, those skilled in the art can understand that the value of each element in the table is an independent embodiment.

In the above embodiment, the terminal may report the target terminal capability to the base station, where the target terminal capability at least includes the maximum uplink duty cycle value corresponding to at least one antenna panel. In order to assist the network side device to more reasonably schedule the terminal's transmitting power and uplink resources within the limits specified by the MPE based on the above target terminal capability. It improves the stability of the terminal's uplink transmission, and also improves the communication coverage and terminal throughput.

In some optional embodiments, refer to FIG. 3, which is a flow chart of a terminal capability reporting method according to an embodiment, which can be used in a terminal. The method can include the following steps.

In step 301, a target terminal capability is reported to a base station, where the target terminal capability at least includes a maximum uplink duty cycle value corresponding to at least one antenna panel of the terminal.

In step 302, at least one of power configuration information and uplink scheduling indication information sent by the base station is received.

In this embodiment of the present disclosure, the power configuration information is used to indicate the maximum transmitting power corresponding to the at least one antenna panel of the terminal, and the uplink scheduling indication information is used to indicate a resource allocation of the terminal when performing uplink scheduling on the at least one antenna panel. In the embodiment, the base station can configure the corresponding maximum transmitting power and uplink scheduling resources based on each antenna panel of the terminal, and send them to the terminal through an RRC signaling. After receiving at least one of the above power configuration information and uplink scheduling instruction information, the terminal can perform power transmission and uplink scheduling on the corresponding antenna panel according to the instructions of the base station.

In the above embodiment, the terminal can receive at least one of the power configuration information and uplink scheduling information sent by the base station, so as to perform subsequent power transmission and uplink scheduling to avoid exceeding the limit range specified by the MPE and to achieve high availability.

In addition, in some possible implementations, before the terminal reports the target terminal capability to the base station, the terminal may receive target signaling sent by the base station, where the target signaling is used to instruct the terminal to report the target terminal capability. That is, the terminal reports the target terminal capability to the base station in response to receiving the target signaling sent by the base station.

Hereinafter, the terminal capability reporting method provided by the present disclosure will be described from the base station side.

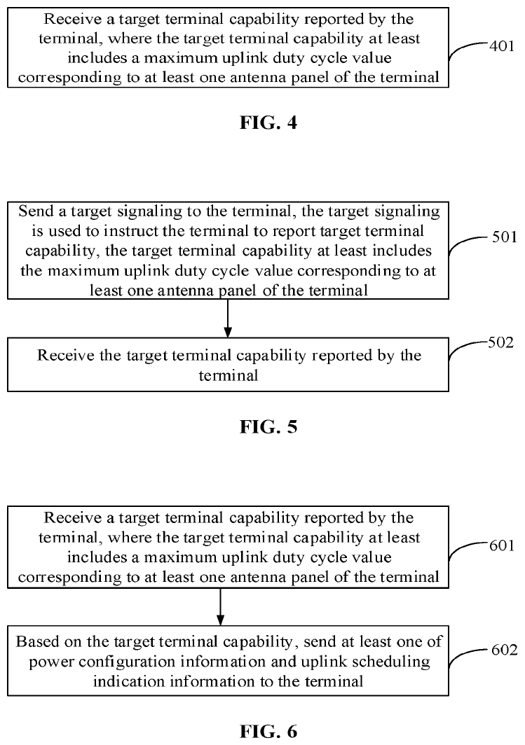

An embodiment of the present disclosure provides a terminal capability reporting method. Refer to FIG. 4, which is a flow chart of a terminal capability reporting method according to an embodiment, which can be used in a base station. The method can include the following steps.

In step 401, a target terminal capability reported by the terminal is received, where the target terminal capability at least includes a maximum uplink duty cycle value corresponding to at least one antenna panel of the terminal.

In the above embodiment, the base station may receive the target terminal capability reported by the terminal, where the target terminal capability at least includes the maximum uplink duty cycle value corresponding to at least one antenna panel of the terminal. This allows the base station to more reasonably schedule the terminal's transmitting power and uplink resources within the limits specified by the MPE based on the above target terminal capability.

In some optional embodiments, refer to FIG. 5, which is a flow chart of a terminal capability reporting method according to an embodiment, which can be used in a base station. The method can include the following steps.

In step 501, a target signaling is sent to the terminal. The target signaling is used to instruct the terminal to report target terminal capability. The target terminal capability at least includes the maximum uplink duty cycle value corresponding to at least one antenna panel of the terminal.

In step 502, the target terminal capability reported by the terminal is received.

In the above embodiment, the base station can send target signaling to the terminal to allow the terminal to report the above target terminal capability, which is simple to implement and has high availability.

In some optional embodiments, the target terminal capability includes a maximum uplink duty cycle value corresponding to each antenna panel of the terminal.

In some optional embodiments, the target terminal capability includes: target configuration information, the target configuration information is used to indicate at least one antenna panel configured to be available on the terminal; and the maximum uplink duty cycle value corresponding to each of the antenna panels of the terminal configured as available.

In some optional embodiments, refer to FIG. 6, which is a flow chart of a terminal capability reporting method according to an embodiment, which can be used in a base station. The method can include the following steps.

In step 601, a target terminal capability reported by the terminal is received, where the target terminal capability at least includes a maximum uplink duty cycle value corresponding to at least one antenna panel of the terminal.

In step 602, based on the target terminal capability, at least one of power configuration information and uplink scheduling indication information is sent to the terminal.

In this embodiment of the present disclosure, the power configuration information is used to indicate the maximum transmitting power corresponding to the at least one antenna panel of the terminal, and the uplink scheduling indication information is used to indicate a resource allocation of the terminal when performing uplink scheduling on the at least one antenna panel. In the embodiment, the base station can configure the corresponding maximum transmitting power and uplink scheduling resources based on each antenna panel of the terminal, and send them to the terminal through an RRC signaling.

In the above embodiment, the base station can configure more reasonable power configuration information and uplink scheduling indication information for the terminal based on the target terminal capability reported by the terminal, thus achieving high availability.

In addition, in some possible implementations, before the base station receives the target terminal capability reported by the terminal, the base station may send target signaling to the terminal, where the target signaling is used to instruct the terminal to report the target terminal capability, that is, the terminal reports the target terminal capability to the base station in respond to receiving the target signaling sent by the base station.

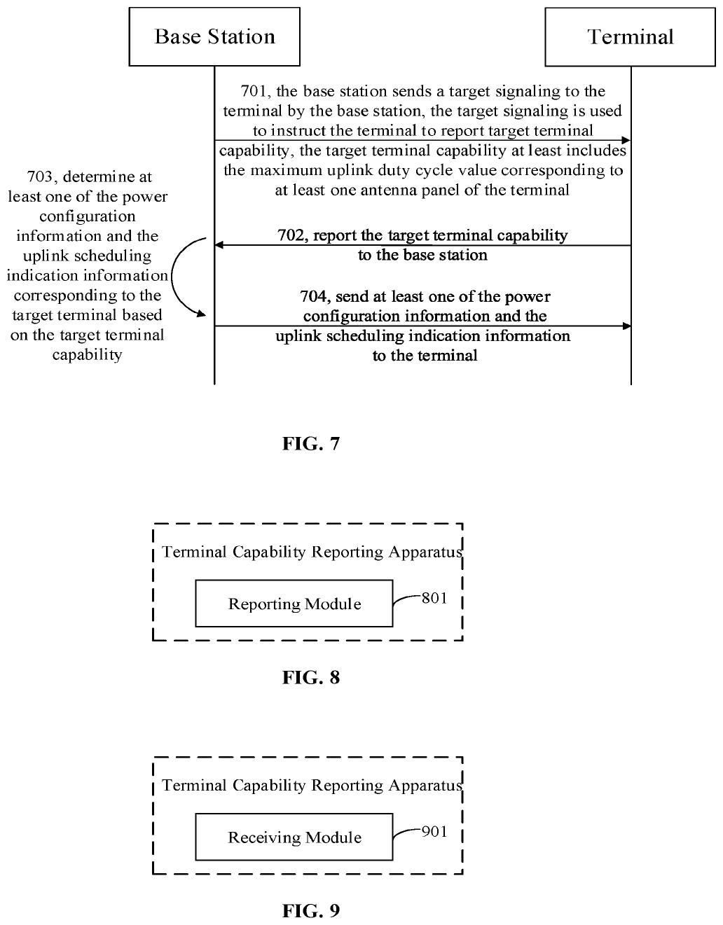

In some optional embodiments, refer to FIG. 7, which is a flow chart of a terminal capability reporting method according to an embodiment. The method may include the following steps.

In step 701, a target signaling is sent to the terminal by the base station. The target signaling is used to instruct the terminal to report target terminal capability. The target terminal capability at least includes the maximum uplink duty cycle value corresponding to at least one antenna panel of the terminal.

In step 702, the target terminal capability is reported to the base station by the terminal.

In a possible example, the target terminal capability includes a maximum uplink duty cycle value corresponding to each antenna panel of the terminal. In another possible example, the target terminal capability includes: target configuration information, the target configuration information is used to indicate at least one antenna panel configured to be available on the terminal; and the maximum uplink duty cycle value corresponding to each of the antenna panel of the terminals configured to be available.

In step 703, at least one of the power configuration information and the uplink scheduling indication information corresponding to the target terminal is determined by the base station based on the target terminal capability. In this embodiment of the present disclosure, the base station configures corresponding power configuration information and uplink scheduling indication information for the terminal based on the received target terminal capability. That is to say, the base station can configure the uplink resources and/or the maximum uplink duty cycle for the terminal based on feedback from the terminal.

In step 704, at least one of the power configuration information and the uplink scheduling indication information is sent to the terminal by the base station.

In the embodiments of the present disclosure, the base station may send the configuration power configuration information and/or the uplink scheduling indication information configured for the terminal to the terminal. In a possible example, the base station may send at least one of power configuration information and uplink scheduling indication information to the terminal through RRC signaling.

In the above embodiment, the terminal may report target terminal capability to the base station, where the target terminal capability at least includes the maximum uplink duty cycle value corresponding to at least one antenna panel. Based on the above target terminal capability, the base station can more reasonably schedule the terminal's transmitting power and uplink resources within the limits specified by the MPE. It improves the stability of the terminal's uplink transmission, and also improves coverage and throughput.

The terminal capability reporting scheme provided by the present disclosure is further illustrated with examples as follows.

For example, the terminal may include three antenna panels, namely antenna panel 1, antenna panel 2 and antenna panel 3.

In a possible implementation, the target terminal capability reported by the terminal to the base station include:
maxuplinkdutycycle-panel[1], maxuplinkdutycycle-panel[2] and maxuplinkdutycycle-panel[3].

That is, the terminal reports the value of maxuplinkdutycycle-panel[i]. In this embodiment, the value of i is 1, 2, and 3.

In another possible implementation, the target terminal capability includes target configuration information and the corresponding maximum uplink duty cycle value. In the embodiment, the target configuration information is used to indicate any of the following: antenna panel 1 transmits alone, antenna panel 2 transmits alone, antenna panel 3 transmits alone, antenna panels 1 and 2 transmit, antenna panels 2 and 3 transmit, antenna panels 1 and 3 transmit, and antenna panels 1, 2 and 3 transmit.

The terminal can maintain Table 1 in the above embodiment.

The terminal can report the content of at least one row in the above Table 1 to the base station as the target terminal capability according to the actual configuration.

It can be understood that each element in Table 1 exists independently, and these elements are exemplarily listed in one table, but it does not mean that all elements in the table must exist at the same time as shown in the table. The value of each element is not dependent on the value of any other element in the table. Therefore, those skilled in the art can understand that the value of each element in the table is an independent embodiment.

In the above embodiment, the terminal may report the target terminal capability to the base station, where the target terminal capability at least includes the maximum uplink duty cycle value corresponding to at least one antenna panel. In order to assist the network side device to more reasonably schedule the terminal's transmitting power and uplink resources within the limits specified by the MPE based on the above target terminal capability. It improves the stability of the terminal's uplink transmission, and also improves the communication coverage and terminal throughput.

In addition, it should be understood that in some possible implementations, the method may omit step 701, that is, the terminal reporting the target terminal capability may not be based on the base station's request, but may be reported by the terminal actively or based on other conditions. Other conditions include but are not limited to reporting immediately after establishing an RRC connection with the base station, or reporting immediately after completing RRC reconfiguration, etc. The above is only an illustrative description. It is well known to those skilled in the art that the ability to report the target terminal in other circumstances should fall within the protection scope of the present disclosure.

Corresponding to the foregoing method embodiments implemented by function, the present disclosure also provides apparatus embodiments implemented by functions.

Referring to FIG. 8, which is a block diagram of a terminal capability reporting apparatus according to an embodiment. The apparatus is applied to a terminal and includes the followings.

The reporting module 801 is configured to report a target terminal capability to a base station, where the target terminal capability at least includes a maximum uplink duty cycle value corresponding to at least one antenna panel of the terminal.

Referring to FIG. 9, which is a block diagram of a terminal capability reporting apparatus according to an embodiment. The apparatus is applied to a base station and includes the followings.

The receiving module 901 is configured to receive a target terminal capability reported by a terminal, where the target terminal capability at least includes a maximum uplink duty cycle value corresponding to at least one antenna panel of the terminal.

As for the apparatus embodiment, since it basically corresponds to the method embodiment, reference may be made to part of the description of the method embodiment for relevant details. The apparatus embodiments described above are only illustrative. The units described above as separate components may or may not be physically separated. The components shown as units may or may not be physical units, that is, they may be located in one place, or can be distributed across multiple network units. Some or all of the modules can be selected according to actual needs to achieve the purpose of the embodiment of the present disclosure. Persons of ordinary skill in the art can understand and implement the method without any creative effort.

Correspondingly, the present disclosure also provides a computer-readable storage medium that stores a non-transitory computer program, and the computer program is used to execute any of the above terminal capability reporting methods for the terminal side.

Correspondingly, the present disclosure also provides a computer-readable storage medium that stores a non-transitory computer program, and the computer program is used to execute any of the above terminal capability reporting methods for the base station side.

Correspondingly, the present disclosure also provides a terminal capability reporting apparatus, including a processor and a memory used to store instructions executable by the processor. The processor is configured to execute any one of the terminal capability reporting methods described above on the terminal side.

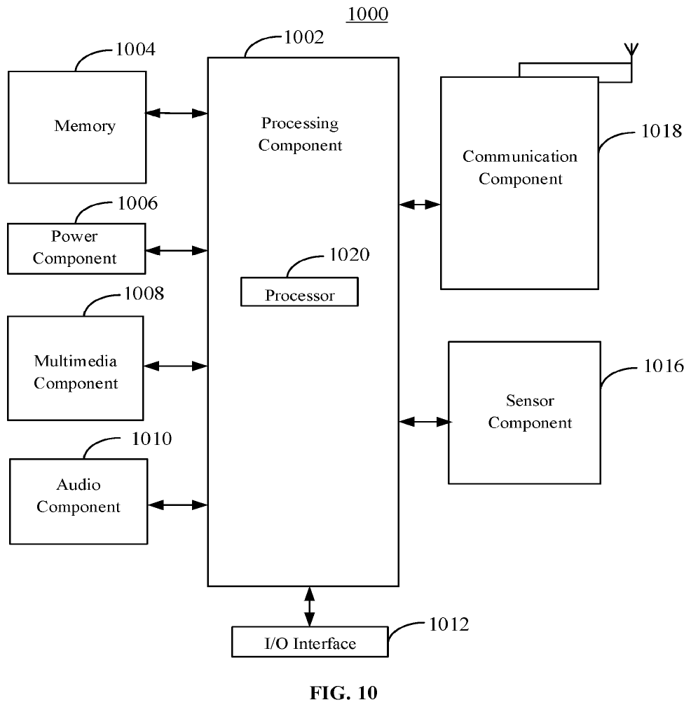

FIG. 10 is a block diagram of a terminal capability reporting apparatus 1000 according to an embodiment. For example, the terminal capability reporting apparatus 1000 may be a mobile phone, a tablet computer, an e-book reader, a multimedia player device, a wearable device, a vehicle-mounted user device, an iPad, a smart TV, and other terminals.

Referring to FIG. 10, the terminal capability reporting apparatus 100 may include one or more of the following components: a processing component 1002, a memory 1004, a power supply component 1006, a multimedia component 10010, an audio component 1010, an input/output (I/O) interface 1012, a sensor component 1016, and a communication component 1018.

The processing component 1002 generally controls the overall operations of the terminal capability reporting apparatus 1000, such as operations associated with display, telephone calls, data random access, camera operations, and recording operations. The processing component 1002 may include one or more processors 1020 to execute instructions to complete all or part of the steps of the above terminal capability reporting method. Additionally, processing component 1002 may include one or more modules that facilitate interaction between processing component 1002 and other components. For example, processing component 1002 may include a multimedia module to facilitate interaction between multimedia component 1008 and processing component 1002. As another example, the processing component 1002 may read executable instructions from the memory to implement the steps of the terminal capability reporting method provided in the above embodiments.

The memory 1004 is configured to store various types of data to support operations at the terminal capability reporting apparatus 1000. Examples of such data include instructions for any application or method operating on the terminal capability reporting apparatus 1000, contact data, phonebook data, messages, pictures, videos, etc. The memory 1004 can be realized by any type of volatile or non-volatile storage device or their combination, such as static random access memory (SRAM), electrically erasable programmable read only memory (EEPROM), erasable programmable read only memory (EPROM), programmable read only memory (PROM), read only memory (ROM), magnetic memory, flash memory, magnetic disk or optical disk.

The power supply component 1006 provides power to various components of the terminal capability reporting apparatus 1000. The power component 1006 may include a power management system, one or more power supplies, and other components associated with generating, managing, and distributing power for terminal capability reporting apparatus 1000.

The multimedia component 1008 includes a display screen providing an output interface between the terminal capability reporting apparatus 1000 and the user. In some embodiments, the multimedia component 1008 includes a front camera and/or a rear camera. When the terminal capability reporting apparatus 1000 is in an operation mode, such as a photographing mode or a video mode, the front camera and/or the rear camera can receive external multimedia data. Each front camera and rear camera can be a fixed optical lens system or have focal length and optical zoom capability.

The audio component 1010 is configured to output and/or input audio signals. For example, the audio component 1010 includes a microphone (MIC), which is configured to receive an external audio signal when the terminal capability reporting apparatus 1000 is in an operation mode, such as a call mode, a recording mode and a voice recognition mode. Received audio signals may be further stored in memory 1004 or sent via communication component 1018. In some embodiments, the audio component 1010 also includes a speaker for outputting audio signals.

The I/O interface 1012 provides an interface between the processing component 1002 and a peripheral interface module, which may be a keyboard, a click wheel, a button, and the like. These buttons may include, but are not limited to: a home button, volume buttons, start button, and lock button.

The sensor component 1016 includes one or more sensors for providing terminal capability reporting apparatus 1000 with various aspects of status assessment. For example, the sensor component 1016 can detect the open/closed state of the terminal capability reporting apparatus 1000, the relative positioning of components, such as the display and the keypad of the terminal capability reporting apparatus 1000, the sensor component 1016 can also detect the terminal capability reporting apparatus 1000 or a change in the position of a component of the terminal capability reporting apparatus 1000, the presence or absence of user's contact with the terminal capability reporting apparatus 1000, the change of orientation or acceleration/deceleration of the terminal capability reporting apparatus 1000 and the temperature change of the terminal capability reporting apparatus 1000. The sensor component 1016 may include a proximity sensor configured to detect the presence of nearby objects in the absence of any physical contact. The sensor component 1016 may also include an optical sensor, such as a CMOS or CCD image sensor, for use in imaging applications. In some embodiments, the sensor component 1016 may also include an acceleration sensor, a gyroscope sensor, a magnetic sensor, a pressure sensor or a temperature sensor.

The communication component 1018 is configured to facilitate wired or wireless communication between the terminal capability reporting apparatus 1000 and other devices. The terminal capability reporting apparatus 1000 can access a wireless network based on any communication standards, such as Wi-Fi, 2G or 3G, 4G, 5G or 6G, or a combination thereof. In an embodiment, the communication component 1018 receives broadcast signals or broadcast related information from an external broadcast management system via a broadcast channel. In an embodiment, the communication component 1018 also includes a near field communication (NFC) module to facilitate short-range communication. For example, the NFC module can be implemented based on radio frequency identification (RFID) technology, infrared data association (IrDA) technology, ultra wideband (UWB) technology, bluetooth (BT) technology and other technologies.

In an embodiment, terminal capability reporting apparatus 1000 may be implemented by one or more application specific integrated circuits (ASIC), digital signal processors (DSP), digital signal processing devices (DSPD), programmable logic devices (PLD), field programmable gate array (FPGA), controllers, microcontrollers, microprocessors or other electronic components for performing any terminal capability reporting method at the terminal side described above.

In an embodiment, there is also provided a non-transitory computer-readable storage medium including instructions, such as the memory 1004 including instructions, which can be executed by the processor 1020 of the terminal capability reporting apparatus 1000 to implement the above terminal capability reporting method. For example, the non-transitory computer readable storage medium may be ROM, random access memory (RAM), CD-ROM, magnetic tape, floppy disk, and optical data storage device, and the like.

Correspondingly, the present disclosure also provides a terminal capability reporting apparatus, including a processor and a memory used to store instructions executable by the processor. The processor is configured to execute any one of the terminal capability reporting methods described above on the base station side.

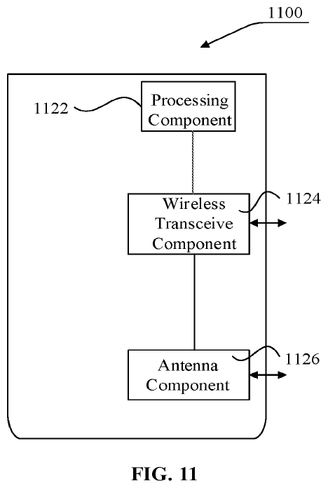

As shown in FIG. 11, which is a schematic structural diagram of a terminal capability reporting apparatus 1100 according to an embodiment. The apparatus 1100 may be provided as a base station. Referring to FIG. 11, the apparatus 1100 includes a processing component 1122, a wireless transmit/receive component 1124, an antenna component 1126, and a wireless interface-specific signal processing portion. The processing component 1122 may further include at least one processor.

One of the processors in the processing component 1122 may be configured to execute any of the terminal capability reporting methods described above on the base station side.

According to a first aspect of an embodiment of the present disclosure, a terminal capability reporting method is provided. The method is applied to a terminal and includes:

reporting a target terminal capability to a base station, wherein the target terminal capability at least includes a maximum uplink duty cycle value corresponding to at least one antenna panel of the terminal.

Optionally, the terminal capability reporting method according to the present disclosure further includes receiving a target signaling sent by the base station, wherein the target signaling is used to instruct the terminal to report the target terminal capability.

Optionally, the target terminal capability includes a maximum uplink duty cycle value corresponding to each antenna panel of the terminal.

Optionally, the target terminal capability includes target configuration information, the target configuration information is used to indicate at least one antenna panel configured to be available on the terminal, and the maximum uplink duty cycle value corresponding to each antenna panel of the terminal that is configured to be available.

Optionally, the terminal capability reporting method according to the present disclosure further includes receiving at least one of power configuration information and uplink scheduling indication information sent by the base station, wherein the power configuration information is used to indicate a maximum transmitting power corresponding to the at least one antenna panel of the terminal, and the uplink scheduling indication information is used to indicate a resource allocation of the terminal when performing uplink scheduling on the at least one antenna panel.

According to a second aspect of an embodiment of the present disclosure, there is provided a terminal capability reporting method, applied to a base station and includes receiving a target terminal capability reported by a terminal, wherein the target terminal capability at least includes a maximum uplink duty cycle value corresponding to at least one antenna panel of the terminal.

Optionally, the terminal capability reporting method according to the present disclosure further includes sending a target signaling to the terminal, wherein the target signaling is used to instruct the terminal to report the target terminal capability.

Optionally, the target terminal capability includes a maximum uplink duty cycle value corresponding to each antenna panel of the terminal.

Optionally, the target terminal capability includes target configuration information, the target configuration information is used to indicate at least one antenna panel configured to be available on the terminal, and the maximum uplink duty cycle value corresponding to each antenna panel of the terminal that is configured to be available.

Optionally, the terminal capability reporting method according to the present disclosure further includes sending at least one of power configuration information and uplink scheduling indication information to the terminal based on the target terminal capability, wherein the power configuration information is used to indicate a maximum transmitting power corresponding to the at least one antenna panel of the terminal, and the uplink scheduling indication information is used to indicate a resource allocation of the terminal when performing uplink scheduling on the at least one antenna panel.

According to a third aspect of an embodiment of the present disclosure, there is provided a terminal capability reporting apparatus, applied to a terminal and includes a reporting module, configured to report a target terminal capability to a base station, wherein the target terminal capability at least includes a maximum uplink duty cycle value corresponding to at least one antenna panel of the terminal.

According to a fourth aspect of an embodiment of the present disclosure, there is provided a terminal capability reporting apparatus, applied to a base station and includes a receiving module, configured to receive a target terminal capability reported by a terminal, wherein the target terminal capability at least includes a maximum uplink duty cycle value corresponding to at least one antenna panel of the terminal.

According to a fifth aspect of an embodiment of the present disclosure, there is provided a computer-readable storage medium, wherein the computer-readable storage medium is stored with a computer program, and the computer program is used to execute the terminal capability reporting method according to any one of the first aspect.

According to a sixth aspect of an embodiment of the present disclosure, there is provided a non-transitory computer-readable storage medium, wherein the computer-readable storage medium is stored with a computer program, and the computer program is used to execute the terminal capability reporting method according to any one of the second aspect.

According to a seventh aspect of an embodiment of the present disclosure, there is provided a terminal capability reporting apparatus, including a processor and a memory configured to store instructions executable by the processor. The processor is configured to execute the terminal capability reporting method according to any one of the first aspect.

According to an eighth aspect of an embodiment of the present disclosure, there is provided a terminal capability reporting apparatus, including a processor and a memory configured to store instructions executable by the processor. The processor is configured to execute the terminal capability reporting method according to any one of the second aspect.

The technical solutions provided by the embodiments of the present disclosure may include the following beneficial effects.

In the embodiment of the present disclosure, the terminal may report target terminal capability to the base station, where the target terminal capability at least includes the maximum uplink duty cycle value corresponding to at least one antenna panel. In order to assist the network side device to more reasonably schedule the terminal's transmitting power and uplink resources within the limits specified by the MPE based on the above target terminal capability. It improves the stability of the terminal's uplink transmission, and also improves coverage and throughput.

Other embodiments of the present disclosure will be readily apparent to those skilled in the art from consideration of the specification and practice of the invention disclosed herein. This disclosure is intended to cover any modification, use or adaptation of the present disclosure, these modifications, uses or adaptations follow the general principles of the present disclosure and include common knowledge or conventional technical means in the technical field not disclosed in this disclosure. The specification and examples are to be considered exemplary only, with a true scope and spirit of the present disclosure being indicated by the following claims.

It should be understood that the present disclosure is not limited to the precise constructions which have been described above and shown in the accompanying drawings, and various modifications and changes may be made without departing from the scope thereof. The scope of the present disclosure is limited only by the appended claims.

1. A terminal capability reporting method, applied to a terminal and comprising:
reporting a target terminal capability to a base station, wherein the target terminal capability at least comprises a maximum uplink duty cycle value corresponding to at least one antenna panel of the terminal.

2. The method according to claim 1, further comprising:
receiving a target signaling sent by the base station, wherein the target signaling is used to instruct the terminal to report the target terminal capability.

3. The method according to claim 1, wherein the target terminal capability comprises a maximum uplink duty cycle value corresponding to each antenna panel of the terminal.

4. The method according to claim 1, wherein the target terminal capability comprises:
target configuration information, the target configuration information is used to indicate at least one antenna panel configured to be available on the terminal; and
the maximum uplink duty cycle value corresponding to each antenna panel of the terminal that is configured to be available.

5. The method according to claim 1, further comprising:
receiving at least one of power configuration information and uplink scheduling indication information sent by the base station, wherein the power configuration information is used to indicate a maximum transmitting power corresponding to the at least one antenna panel of the terminal, and the uplink scheduling indication information is used to indicate a resource allocation of the terminal when performing uplink scheduling on the at least one antenna panel.

6. A terminal capability reporting method, applied to a base station and comprising:
receiving a target terminal capability reported by a terminal, wherein the target terminal capability at least comprises a maximum uplink duty cycle value corresponding to at least one antenna panel of the terminal.

7. The method according to claim 6, further comprising:
sending a target signaling to the terminal, wherein the target signaling is used to instruct the terminal to report the target terminal capability.

8. The method according to claim 6, wherein the target terminal capability comprises a maximum uplink duty cycle value corresponding to each antenna panel of the terminal.

9. The method according to claim 6, wherein the target terminal capability comprises:
target configuration information, the target configuration information is used to indicate at least one antenna panel configured to be available on the terminal; and
the maximum uplink duty cycle value corresponding to each antenna panel of the terminal that is configured to be available.

10. The method according to claim 6, further comprising:
sending at least one of power configuration information and uplink scheduling indication information to the terminal based on the target terminal capability, wherein the power configuration information is used to indicate a maximum transmitting power corresponding to the at least one antenna panel of the terminal, and the uplink scheduling indication information is used to indicate a resource allocation of the terminal when performing uplink scheduling on the at least one antenna panel.

11-12. (canceled)

13. A non-transitory computer-readable storage medium, wherein the computer-readable storage medium is stored with a computer program, and the computer program is used to execute the terminal capability reporting method according to claim 1.

14. A non-transitory computer-readable storage medium, wherein the computer-readable storage medium is stored with a computer program, and the computer program is used to execute the terminal capability reporting method according to claim 6.

15. A terminal capability reporting apparatus, comprising:
a processor; and
a memory configured to store instructions executable by the processor;
wherein, the processor is configured to execute;
reporting a target terminal capability to a base station, wherein the target terminal capability at least comprises a maximum uplink duty cycle value corresponding to at least one antenna panel of the terminal.

16. A terminal capability reporting apparatus, comprising:
a processor; and
a memory configured to store instructions executable by the processor;
wherein, the processor is configured to execute the terminal capability reporting method according to claim 6.

17. The terminal capability reporting apparatus according to claim 15, wherein the processor is further configured to execute:
receiving a target signaling sent by the base station, wherein the target signaling is used to instruct the terminal to report the target terminal capability.

18. The terminal capability reporting apparatus according to claim 15, wherein the target terminal capability comprises a maximum uplink duty cycle value corresponding to each antenna panel of the terminal.

19. The terminal capability reporting apparatus according to claim 15, wherein the target terminal capability comprises:
target configuration information, the target configuration information is used to indicate at least one antenna panel configured to be available on the terminal; and
the maximum uplink duty cycle value corresponding to each antenna panel of the terminal that is configured to be available.

20. The terminal capability reporting apparatus according to claim 15, wherein the processor is further configured to execute:
receiving at least one of power configuration information and uplink scheduling indication information sent by the base station, wherein the power configuration information is used to indicate a maximum transmitting power corresponding to the at least one antenna panel of the terminal, and the uplink scheduling indication information is used to indicate a resource allocation of the terminal when performing uplink scheduling on the at least one antenna panel.
